(19) United States
(12) Patent Application Publication
(10) Pub. No.: US 2003/0099196 A1
(43) Pub. Date: May 29, 2003

(54) Radio bearer service for IMS services

(76) Inventor: Benoist Sebire, Espoo (FI)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/990,331

(22) Filed: Nov. 23, 2001

(51) Int. Cl. H04L 12/26; H04Q 7/24

(52) U.S. Cl. 370/230; 370/349

(57) ABSTRACT

A method and apparatus are provided for transmitting packets across a radio access network. This may include identifying a first part of a packet and a second part of the packet and classifying one of the first part and the second part as being more important than the other part. This may further include transmitting the more important part of the packet differently than the less important part of the packet.

### BACKGROUND OF THE INVENTION

1. Field Of The Invention

The present invention is directed to multimedia services. More particularly, the present invention is directed to the use of multiple radio bearers for multimedia services,

2. Background of Related Art

Third generation mobile communication systems include the Universal Mobile Telecommunication System (UMTS). Multimedia services will be supported by UMTS according to the 3^{rd} Generation Partnership Project (3GPP) specification.

For core networks (CN), the traditional circuit switched network will evolve into modern packet switched networks such as IP-based networks. Due to the merging of internet and mobile applications, UMTS users are capable of accessing both telecom and internet resources. But since IP networks historically provide best efforts service and are not multimedia oriented, Quality of Service (QoS) is an issue for the success of UMTS. To provide end users with perceptive QoS, network resources at various nodes may need to be optimally utilized. Therefore, resource management plays an important role in the future of UMTS services.

### SUMMARY OF THE INVENTION

Embodiments of the present invention may provide a method that includes identifying a first part of a packet and a second part of the packet. The method may also include classifying one of the first part and the second part as being more important and classifying the other part as being less important. The more important part of the packet may be transmitted differently than the less important part of the packet.

The packet may be a UDP packet and the classifying may be based on data in a checksum coverage field of the UDP packet. On the other hand, the packet may be an RTP packet and the classifying may be based on data in a payload type field of the RTP packet.

The more important part of the packet may be transmitted using a first radio bearer and the less important part may be transmitted using a second radio bearer. The more important part may be transmitted using stronger channel coding than channel coding for the less important part.

The packet may be received from a multimedia network at a UMTS system. The first part and the second part of the packet may be transmitted over a radio access network to a mobile terminal.

Embodiments of the present invention may also provide a method of transmitting a packet. This may include transmitting a first part of the packet across a radio access network using a first radio bearer and transmitting a second part of the packet across the radio access network using a second radio bearer.

Embodiments of the present invention may further provide an apparatus to communicate a packet across a radio access network. The apparatus may include structure to identify a first part of the packet and a second part of the packet. The structure may also transmit the first part of the packet across the radio access network using a first radio bearer and transmit the second part of the packet across the radio access network using a second radio bearer.

Other embodiments, objects, advantages and salient feature of the invention will become apparent from the following detailed description taken in conjunction with the annexed drawings, which disclose preferred embodiments of the present invention.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and that the invention is not limited thereto.

Arrangements and embodiments of the present invention may be described with reference to the following drawings in which like reference numerals represent like elements and wherein:

FIG. 1 is an example UMTS architecture;

FIG. 2 is a block diagram of an example mobile terminal;

FIG. 3 is an example bearer and QoS architecture;

FIG. 4 is an example UDP Lite header;

FIG. 5 is an example RTP header; and

FIG. 6 is a flowchart showing a method of transmitting UDP packets across a radio access network according to an example embodiment of the present invention.

### DETAILED DESCRIPTION OF PREFERRED EMBODIMENTS

In the following detailed description, like reference numerals and characters may be used to designate identical, corresponding or similar components in differing figure drawings. Further, arrangements may be shown in block diagram form in order to avoid obscuring the invention, and also in view of the fact that specifics with respect to implementation of such block diagram arrangements may be highly dependent upon the platform within which the present invention is to be implemented. That is, such specifics should be well within the purview of one skilled in the art. Where specific details (e.g., circuits, flowcharts) are set forth in order to describe example embodiments of the invention, it should be apparent to one skilled in the art that the invention can be practiced without, or with variation of, these specific details. Finally, it should be apparent that differing combinations of hard-wired circuitry and software instructions may be used to implement embodiments of the present invention. That is, the present invention is not limited to any specific combination of hardware and software.

Embodiments of the present invention may be described with respect to a method or apparatus for communicating a packet between a mobile terminal (in a radio access network) and a multimedia network. This may include identifying a first part of a packet (such as a UDP packet or a RTP packet) and a second part of the packet. One of the first part of the second part may be classified as being more important. For UDP packets, this classification may be based on the checksum coverage field. For RTP packets, this classification may be based on the payload type field. The more important part of the packet may be transmitted (over the air interface of the radio access network) differently than the less important part of the packet.

An Internet Protocol (IP) Multimedia Subsystem (IMS) may utilize a packet switched (PS) domain to transport multimedia signaling and bearer traffic. From the mobile user perspective, a UMTS network is a network to access multimedia services of IMS. IP Multimedia Systems are discussed in each of the following: (1) 3GPP TS 22.228 entitled “Service Requirements for the IP Multimedia Core Network Subsystems”; (2) 3GPP TS 23.228 entitled “IP Multimedia Subsystems”; and (3) 3GPP TR 22.941 entitled “IP Based Multimedia Services Framework.” The subject matter of each of these references is hereby incorporated by reference.

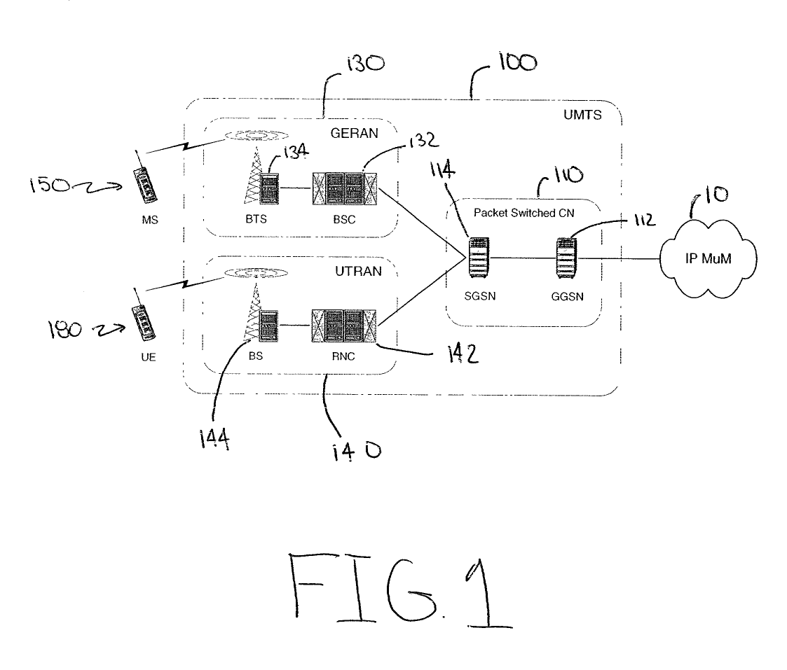

FIG. 1 illustrates a UMTS architecture according to one arrangement. Other arrangements are also possible. The arrangements shown in FIG. 1 will be used to describe embodiments of the present invention. Other architectures (including other radio access networks) may also be used in conjunction with embodiments of the present invention.

More specifically, FIG. 1 shows a UMTS 100 coupled to a multimedia network 10 (such as the internet, for example). The UMTS 100 may include a packet switched core network 110, a GSM Radio Access Network (GERAN) 130 and a UMTS Radio Access Network 140. The packet switched core network (CN) 110 may include a Gateway GPRS Support Node (GGSN) 112 coupled to the network 10 and a Serving GPRS Support Node (SGSN) 114 coupled to the GGSN 112. The GERAN 130 may include a base station controller 132 coupled to the SGSN 114 and a base transceiver station (BTS) 134 coupled to the BSC 132. The BTS 134 may communicate with a mobile station (MS) 150 in a well-known manner. Likewise, the UTRAN 140 may include a Radio Network Subsystem (RNC) 142 coupled to the SGSN 114 and a base station (BS) 144 coupled to the RNS 142. The BS 144 may communicate with user equipment (UE) 180 in a well-known manner. For ease of illustration, embodiments and arrangements may be described with respect to the MS 150 rather than the UE 180.

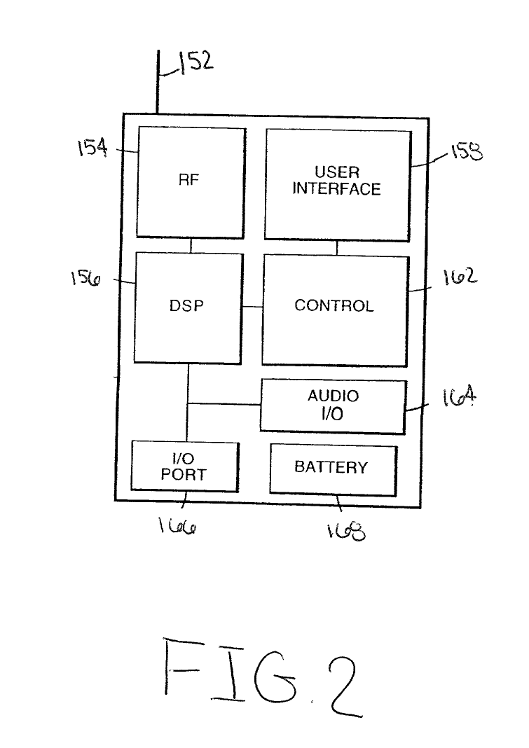

FIG. 2 illustrates an example mobile station (such as the MS 150) according to one arrangement. Other arrangements are also possible. The mobile station 150 may include an RF antenna 152; an RF (analog) transceiver circuit 154; a digital signal processing circuit 156; a user interface section 158 (including an LCD screen and keypad); a control circuit 162; an audio interface 164 (including a loud speaker and a microphone); an input/output port for digital data 166; and a battery 168.

In use, the digital signal processor circuit 156 may operate in one of several different modes under control of the control circuit 162 to selectively interconnect with the input/output port 166 or the audio interface 164 with the RF transceiver circuit 154 to set up either a voice or a data communication session. The digital signal processing circuit 156 may perform data formatting (e.g. into packets, ATM cells or a TDM bit stream and into a frame structure); data encryption; redundancy reduction encoding and decoding; and other well-known functions.

The RF transceiver circuit 154 may receive the output bit stream from the digital signal processing circuit 156 and modulate the output bit stream onto an RF channel including, for example, one or more time slots on one or more frequency carriers or one or more codes in a CDMA system.

IMS services available through UMTS (i.e., both GERAN and UTRAN) may include IMS Basic Multimedia Service, IMS Basic Voice Service and IMS Videophone Service, for example. Other services are also possible.

Subscribers to the IMS Basic Multimedia Services may be able to address, access and present in their terminals (such as the MS 150 and/or the UE 180) different types of multimedia objects. The media types may include real-time voice, text, and video. The use of the different media may depend on the capabilities of the user's device and the supporting networks. This may include the following: audio download, video download, audio streaming, video streaming, general data files, text messaging (e.g. SMS), emails, general web browsing and multi-media messaging.

Subscribers to the IMS Basic Voice Service may be able to make and receive conversational class voice calls via the IMS to/from all types of network (within IMS, GSM, PSTN, etc).

Subscribers to the IMS Videophone Service may be able to make and receive conversational class videophone calls if the user devices (such as the MS 150) can support the video component and compatible codecs and all the networks used by the call, end to end, are capable of supporting it. The Videophone Service may also provide the same capabilities as the Voice Service.

QoS is the collective effect of service performances that determines the degree of satisfaction of a user of a service. The end user may decide whether he is satisfied with the provided QoS or not. The end-to-end Quality of Service (QoS) requirements may need to be met everywhere in the network. Thus, every entity of the network (and in particular the radio access network) may contribute to fulfill the QoS requirements.

A QoS architecture (such as a UMTS bearer service layered architecture) may be defined in order to ensure the end-to-end QoS requirements. QoS requirements are discussed in 3GPP TS 23.107 entitled “QoS Concept and Architecture” and in 3GPP TS 23.207 entitled “End-to-End QoS Concept and Architecture,” the subject matters of which are incorporated herein by reference.

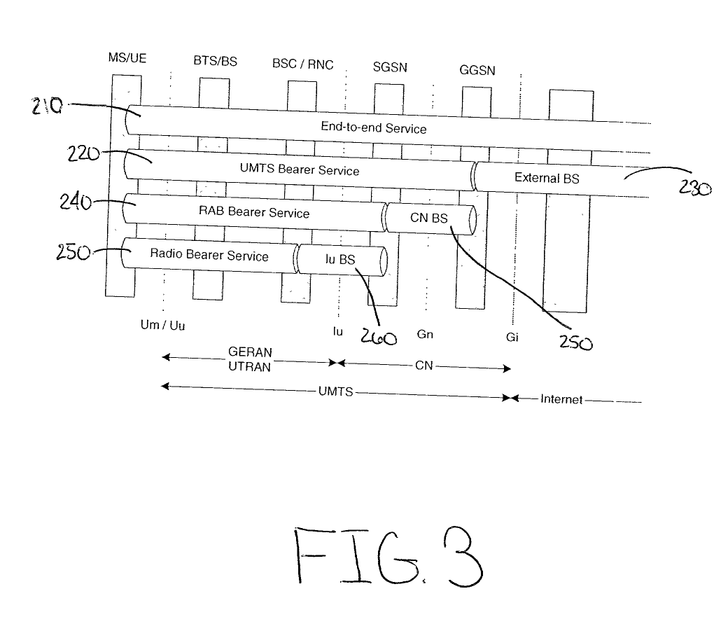

FIG. 3 illustrates one example bearer and QoS architecture. Other types of bearer and QoS architectures are also possible. FIG. 3 shows the different hierarchies of services. By introducing different hierarchies of services, the QoS architecture allows the QoS to be controlled at different levels, and within different elements along the transmission chain. Every element should fulfill the QoS requirements since it only takes one faulty element to jeopardize all of the QoS. As is well known in the art, a bearer is a service providing QoS between two defined points. More specifically, a bearer service is a type of telecommunication service that provides the capability of transmission of signals between access points. The characterization of a bearer service may be made by using a set of end-to-end characteristics with requirements on QoS, which distinguishes it from other bearer services (e.g., data rate, delay, information loss). Particular values are assigned to each characteristic when a given bearer service is described and defined. The bearer services are negotiable and may be used flexibly by applications.

An end-to-end QoS service 210 may be ensured by two services, namely an external bearer service 230 and a UMTS bearer service 220. The external bearer service 230 may manage the QoS within an external networks (such as the internet) and the UMTS bearer service 220 may contain mechanisms to allocate QoS over the UMTS network (such as the UMTS 100). Both the external bearer service 230 and the UMTS bearer service 220 should fulfill the QoS requirements in order to guarantee the end-to-end QoS.

The UMTS 100 may act as an infrastructure allowing services to be provided, and maintained while the terminal (such as the MS 150) moves and hides from the IP multimedia subsystem (such as the network 10). As further shown in FIG. 3, the UMTS bearer service 220 may be split into two services, namely a radio access bearer (RAB) service 240 and a core network bearer service (CN BS) 250. Both the RAB service 240 and the CN BS service 250 may reflect the optimized way to realize the UMTS bearer service 220 over a cellular network topology. The RAB bearer service 240 may be split into two services, namely a radio bearer (RB) service 250 and a lu bearer service 260.

A split of the RAB bearer service 240 allows the CN 110 to be independent from the radio access technology used by the RAN (i.e., the GERAN 130 and/or the UTRAN 140). The radio access network may create and maintain radio access bearers (RAB) for communication between the MS 150 (or the UE 180) and the CN 110. The RAB may give the CN 110 the illusion of a fixed communication, which thereby relieves the CN 110 of radio related aspects. The RAN and the CN 110 may map the end-to-end QoS requirements over the lu interface (i.e., the lu bearer services 260), while the RAN may only satisfy the QoS requirements over the radio path (Uu/Um) with the radio bearer service 250.

As will be described, embodiments of the present invention may utilize the information contained in UDP headers (or RTP headers) in order to optimize the radio bearer service (such as the radio bearer service 250) of the radio access network for real-time IMS services. Embodiments of the present invention will first be described with respect to UDP headers followed by RTP headers.

Embodiments of the present invention may utilize headers in accordance with the UDP Lite Protocol. UDP Lite is described in the IETF Draft entitled “The UDP Lite Protocol,” the subject matter of which is incorporated herein by reference. The UDP Lite Protocol is similar to UDP, but is directed toward applications that can handle a partially damaged payload in lossy network environments. UDP is described in RFC 768 entitled “The User Datagram Protocol” (at http://www.ietf.org/rfc/rfc0792.txt), the subject matter of which is incorporated herein by reference.

The UDP Lite header contains a checksum coverage field. The value stored in the checksum coverage field is the number of bytes (counting from the first byte of the UDP Lite header) that are covered by the checksum field. Stated differently, the checksum coverage field may act as an indication of a more important part of the UDP packet. The more important part of the UDP packet may be more protected in the channel coding for transmission to and from the MS 150. Stated differently, the radio access network may include structure (through software or hardware) to examine the checksum coverage field of the UDP Lite header in order to determine the more important part of the UDP packet. The more important part of the UDP packet may then receive better channel coding than the less important part (i.e., the part not within the checksum) when the UDP packet is transmitted to (or from) the MS 150.

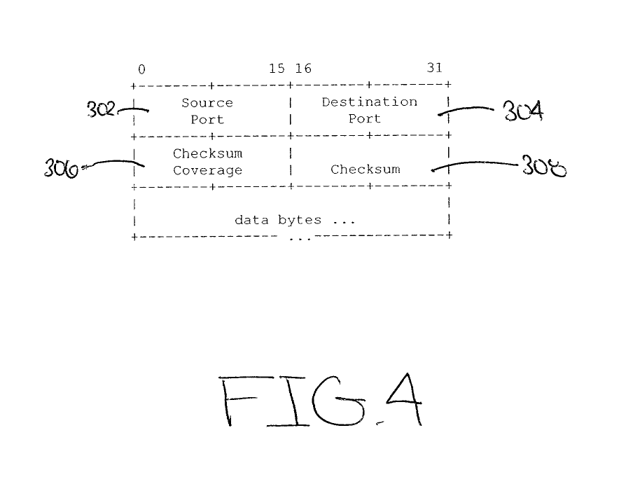

More specifically, FIG. 4 illustrates a UDP Lite header. The format of the UDP Lite header differs from a classic UDP header in that the UDP length field is replaced with a checksum coverage field. This can be done since information about the UDP Lite packet length can be found in the length field of the IP pseudo-header. FIG. 4 shows a source port field 302 and a destination port field 304. These fields are defined in RFC-768. FIG. 4 also shows a checksum coverage field 306 and a checksum field 308. The checksum coverage field 306 may be the number of bytes (counting from the first byte of the UDP Lite header) that are covered by the checksum field 308. The UDP Lite header is included in the total of the checksum. Despite this requirement, the checksum coverage field 306 is expressed in bytes from the beginning of the UDP Lite header in order to preserve compatibility with classic UDP. An indication of zero in the checksum coverage field may indicate that the entire UDP Lite package is included in the checksum total. This means that the value of the checksum coverage field 306 is either zero or at least eight.

The checksum field 308 is a 16-bit one's complement of the one's complement sum of a pseudo-header of information from the IP header, the number of bytes specified by the checksum coverage field 306 (starting at the first byte in the UDP Lite header) virtually padded with zero bytes at the end (if necessary) to make a multiple of two bytes. If the computed checksum is zero, then it may be transmitted as all ones (the equivalent in one's complement arithmetic). The transmitted checksum is not all zeroes.

Embodiments of the present invention may utilize the checksum coverage field 306 of the UDP Lite header to split (or separate) the UDP packet into two parts and then transmit the split UDP packet over two different radio bearers. That is, the part of the UDP packet that is covered by the checksum may be carried (or transmitted) by a first radio bearer, and the part of the UDP packet that is not covered by the checksum may be carried (or transmitted) by a second radio bearer. The second radio bearer may have more relaxed requirements in terms of error protection (and/or error detection) than the first radio bearer. For instance, channel coding of the part associated with the second radio bearer may be lighter (i.e., the coding rate may be higher) than the channel coding associated with the first radio bearer. Such a split of the UDP packet may allow unequal error protection (UEP) to be used. This may also increase the spectral efficiency.

For downlink traffic from the RAN to the MS 150, the split of the UDP packet may be performed in the RAN (such as the GERAN 130 and the UTRAN 140) while the MS 150 merges the two radio bearers together in order to recover the original UDP packets. For uplink traffic from the MS 150 to the RAN, the split of the UDP packet may be performed in the MS 150 while the RAN merges the two radio bearers together. The two radio bearers may need to be synchronized in time.

Stated differently, embodiments of the present invention may utilize properties of the UDP Lite protocol in order to interpret the UDP packet as having two parts with one part being more important than the other part. Based on this information, unequal error protection may be provided between these two parts at the physical layer for transmission over the air interface (either to or from the MS 150, for example). Accordingly, embodiments of the present invention may identify two parts in the UDP packet based on the checksum coverage field of the UDP packet. The two parts may be classified by the level of importance with respect to whether or not it is covered by the checksum. The part on which the checksum is applied is defined as being more important than the other part on which no checksum applies. Further, unequal error protection may be applied at the physical layer between the two parts.

If the UDP Lite protocol is not available, then the split of the packet may be based on the payload type field (PT) of the RTP packet. RTP packets are described in RFC 1889 entitled “Real Time Protocol,” http://www.ietf.org/rfc/rfc1889.txt, the subject matter of which is incorporated herein by reference.

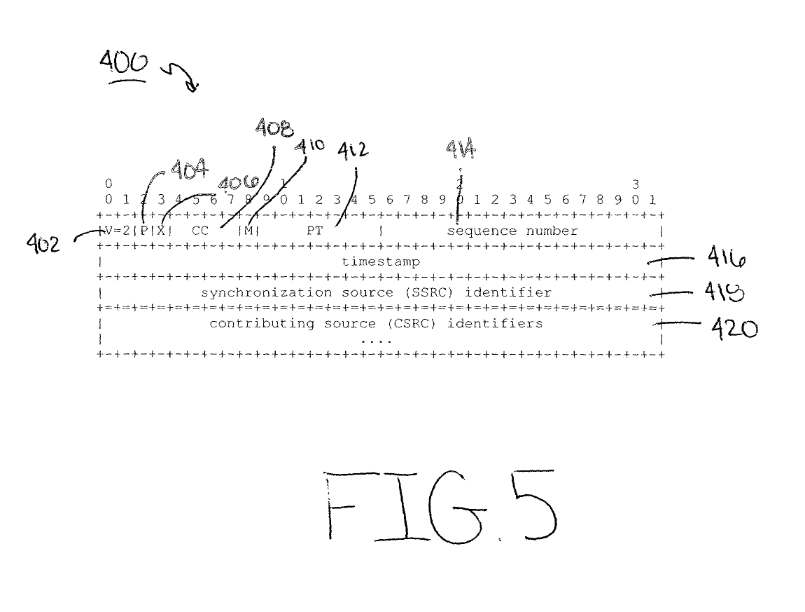

FIG. 5 illustrates a RTP header as described in RFC 1889. More specifically, the RTP header 400 includes a version field 402, a padding field 404, an extension field 406, a CSRC field 408, a marker field 410, a payload type (PT) field 412 and a sequence number field 414. The RTP also includes a timestamp field 416, a SSRC field 418 and a CSRC field 420. The PT field 412 identifies the RTP payload format, and consequently identifies the content of the RTP packet. This information may be used to split the RTP packet into as many parts as necessary and carry them over different radio bearers. In a similar manner as discussed above, one radio bearer may carry each part.

For example, the RTP payload format that is being defined for Adaptive Multi-Rate (AMR) may define a Frame Type indicator. This may tells the codec mode of the AMR frame that is carried. From this information, it is possible to deduce where different classes of bits are located within the RTP packet. One can then split the RTP packet into several parts and put them into different radio bearers based on their different classes. This may include the following: (1) RTP header and class 1A bit; (2) class 1B bit; and (3) class 2 bits.

However, this technique may utilize apriori knowledge of the RTP payload format. The main problem is then whenever a newly introduced payload format is unknown within the entity that has to perform the split, then the split may not be possible.

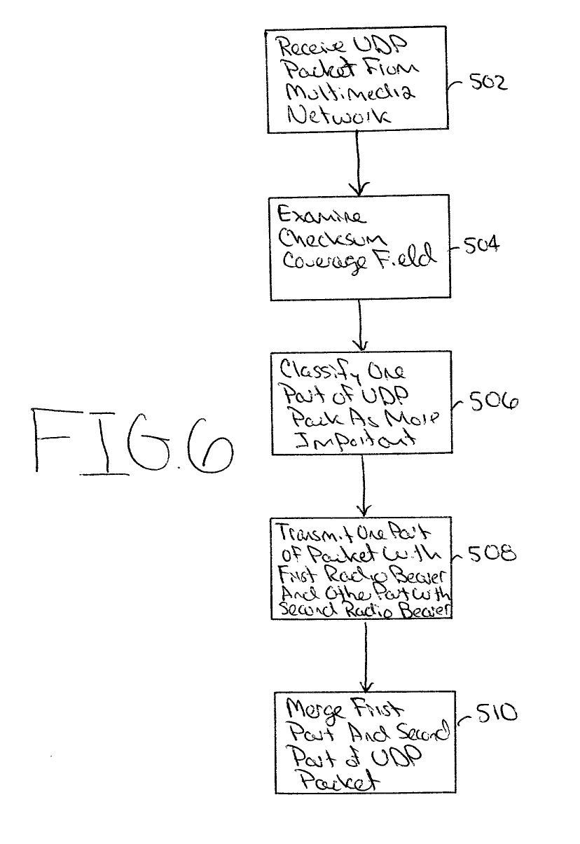

FIG. 6 is a flowchart showing operations to perform a method of transmitting a UDP packet from a multimedia network to a mobile terminal across a radio access network in accordance with an example embodiment of the present invention. Other operations and orders of operations are also within the scope of the present invention. More specifically, FIG. 6 shows a UMTS receiving the UDP packet from a multimedia network in block 502. In block 504, the UMTS (such as the GERAN or the UTRAN) may examine the checksum coverage field of the UDP packet. Based on this examination, in block 506 the UMTS may identify (or classify) one part of the UDP packet as being more important than another part of the UDP packet. In block 508, the UMTS may transmit the first part over a radio access network using a first radio bearer and may transmit the second part over the radio access network using a second radio bearer. In block 510, the mobile terminal may merge the first part and the second part of the UDP packet. The merging may be performed by the digital signal processing circuit 156 (FIG. 2), for example. Embodiments of the present invention are also applicable to the mobile terminal (such as the digital signal processing circuit 156) identifying the more important part of the packet and then transmitting the two parts across the radio access network to the UMTS using two radio bearers. The RAN may then merge the two parts.

Embodiments of the present invention have been described with respect to a method of transmitting a packet. This method may include transmitting a first part of the packet across a radio access network using a first radio bearer and transmitting a second part of the packet across the radio access network using a second radio bearer.

Embodiments or portions of embodiments of the present invention may be practiced as a software invention, implemented in the form of a machine-readable medium having stored thereon at least one sequence of instructions that, when executed, causes a machine to effect the invention. With respect to the term “machine”, such term should be construed broadly as encompassing all types of machines, e.g., a non-exhaustive listing including: computing machines, non-computing machines, communication machines, etc. Similarly, which respect to the term “machine-readable medium”, such term should be construed as encompassing a broad spectrum of mediums, e.g., a non-exhaustive listing including: magnetic medium (floppy disks, hard disks, magnetic tape, etc.), optical medium (CDROMs, DVD-ROMs, etc.), etc.

Any reference in this specification to “one embodiment”, “an embodiment”, “example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A method comprising:
identifying a first part of a packet and a second part of said packet;
classifying one of said first part and said second part as being more important and classifying said other part as being less important; and
transmitting said more important part of said packet differently than said less important part of said packet.

2. The method of claim 1, wherein said packet comprises a UDP packet.

3. The method of claim 2, wherein said classifying is based on data in a checksum coverage field of said UDP packet.

4. The method of claim 1, wherein said transmitting comprises transmitting said more important part using a first radio bearer and transmitting said less important part using a second radio bearer.

5. The method of claim 4, wherein said transmitting further comprises transmitting said more important part using stronger channel coding than channel coding for said less important part.

6. The method of claim 1, wherein said packet comprises an RTP packet.

7. The method of claim 6, wherein said classifying is based on data in a payload type field of said RTP packet.

8. The method of claim 1, further comprising receiving said packet from a multimedia network.

9. The method of claim 8, wherein said packet is received at a UMTS system.

10. The method of claim 9, wherein said first part and said second part of said packet are transmitted over a radio access network to a mobile terminal.

11. A method of transmitting a packet comprising:
transmitting a first part of said packet across a radio access network using a first radio bearer; and
transmitting a second part of said packet across said radio access network using a second radio bearer.

12. The method of claim 11, wherein said packet comprises a UDP packet.

13. The method of claim 12, further comprising determining said first part and said second part based on data in a checksum coverage field of said UDP packet.

14. The method of claim 11, wherein transmitting said first part comprises transmitting said first part using a first type of channel coding, and transmitting said second part comprises transmitting said second part using a second type of channel coding, said first type of channel coding being greater than said second type of channel coding.

15. The method of claim 11, wherein said packet comprises an RTP packet.

16. The method of claim 15, further comprising determining said first part and said second part based on data in a payload type field of said RTP packet.

17. The method of claim 11, further comprising receiving a packet from a multimedia network.

18. An apparatus to communicate a packet, said apparatus including structure to identify a first part of said packet and a second part of said packet, and structure to transmit said first part of said packet across a radio access network using a first radio bearer and to transmit said second part of said packet across said radio access network using a second radio bearer.

19. The apparatus of claim 18, wherein said structure is provided in a mobile terminal.

20. The apparatus of claim 18, wherein said structure is provided in said radio access network so as to transmit said first part and said second part to a mobile terminal.
